(19) United States
(12) Patent Application Publication
(10) Pub. No.: US 2018/0230792 A1
(43) Pub. Date: Aug. 16, 2018

(54) ROTATING SEAL FOR WIRELINE APPLICATIONS AND METHODS OF USING THE SAME

(71) Applicant: PIEZOTECH, LLC, INDIANAPOLIS, IN (US)

(72) Inventors: SETH FRIEDLY, Longmont, CO (US); GREGORY PULLEY, Loveland, CO (US)

(21) Appl. No.: 15/433,175

(22) Filed: Feb. 15, 2017

(51) Int. Cl. E21B 47/01; F16J 15/43; F16J 15/3204

(52) U.S. Cl. CPC E21B 47/011; F16J 15/3204; F16J 15/43

(57) ABSTRACT

A method of determining information inside a borehole is provided. The method includes the use of a ferrofluid seal to seal a rotating shaft used in the borehole. In preferred embodiments, the method comprises: selecting at least one sensor to be lowered into the borehole; coupling the sensor to the end of a rotating shaft; running the rotating shaft through a housing including a plurality of bearings and an oil reservoir, sealing a downhole end of the housing from an exterior of the housing with a ferrofluid seal; and forcing the sensor, rotating shaft, housing, bearings, oil reservoir, and ferrofluid seal into the borehole to make a measurement.

### FIELD

The present patent document relates generally to seals for use with rotating parts. More specifically, the present patent document relates to magnetic liquid seals for use with rotating shafts in downhole operations.

### BACKGROUND

The implementation of a seal system on a rotating shaft exposed to high temperature and pressure is a challenge. This is particularly true in the oil and gas industry where borehole condition can become extreme. Such a seal system must both seal off the internal tool oil from the borehole fluids downhole while the shaft is rotating at temperatures in excess of 150° C., and also contain the tool oil while the shaft is stationary during storage or transport at surface temperatures as low as −40° C. Additionally, the seal must not create any significant friction that could result in elevated motor power requirements to spin the shaft.

In wireline applications, the same metal or polymer mechanical seal designs have been state of the wireline art for three decades. These conventional seals have poor performance: short functional lifetime requiring adjustment or replacement after 10's of hours, leak tool oil when stored, allow borehole fluid ingress and increase motor torque requirements. When a standard metal or polymer seal leaks due to coefficient of thermal expansion mismatches or adds significant torque load, the issues are worked around by adding additional fluid to the reservoir or a bigger motor to the design to compensate. That is industry practice. What is needed is a new seal design that eliminates or at least ameliorates some of the issues with current seal designs in the wireline industry.

### SUMMARY OF THE EMBODIMENTS

The embodiments of the present patent document provide methods and assemblies to seal a rotating shaft from the environments found in boreholes and other downhole applications. In preferred embodiments, wireline instruments and downhole instruments are sealed using the methods and seals disclosed herein. Accordingly, methods of determining information inside a borehole are provided. In a preferred embodiment, the method of determining information in a borehole comprises: selecting at least one sensor to be lowered into the borehole; coupling the sensor to the end of a rotating shaft; running the rotating shaft through a housing including a plurality of bearings and an oil reservoir, sealing a downhole end of the housing from an exterior of the housing with a ferrofluid seal; and forcing the sensor, rotating shaft, housing, bearings, oil reservoir, and ferrofluid seal into the borehole.

In some embodiments, the ferrofluid seal may be especially designed to meet exceedingly high pressures and temperatures. Accordingly, in some embodiments, the ferrofluid seal includes an elastomer seal on each end of a ferrofluid reservoir. In embodiments with elastomer seals, the elastomer seals may be lip seals.

In some embodiments, the ferrofluid seal includes a ferrofluid reservoir made from a slurry of ferromagnetic particles combined with oil or grease. In other embodiments, the ferrofluid seal includes a ferrofluid reservoir made from a slurry of ferromagnetic particles and a fluid comprising about 68 wt % Ga, 22 wt % In and 10 wt % Sn.

In addition to the methods disclosed herein, ferrofluid seal designs are also provided. The ferrofluid seal is designed to seal against a rotating shaft. In some embodiments, the ferrofluid seal comprises: a magnetic assembly with a cylindrically shaped interior that surrounds the rotating shaft including at least one permanent magnet; a bushing between the cylindrically shaped interior of the magnetic assembly and the rotating shaft; a reservoir of ferrofluid that surrounds the rotating shaft and is between the bushing and the rotating shaft; an elastomer seal that forms a ring around the rotating shaft and is located on a downhole side of the reservoir and spans a gap between the bushing and the rotating shaft; and, a second elastomer seal that forms a ring around the rotating shaft and is located on an opposite side of the reservoir from the downhole side and spans the gap between the bushing and the rotating shaft.

In some embodiments, the ferrofluid seal may have a custom bushing design. Accordingly, in some embodiments, the bushing has a plurality of channels formed on an inside surface of the bushing.

In yet other embodiments, the magnetic assembly of the ferrofluid seal comprises a first cylindrically shaped permanent magnet on the downhole end of the magnetic assembly and a second cylindrically shaped permanent magnet on an opposite end of the magnetic assembly wherein a pole is formed in between the first and second cylindrically shaped permanent magnets.

In another aspect of the current embodiments and designs, a method of sealing a rotating shaft on a downhole instrument is provided. In preferred embodiments, the method comprises: running the rotating shaft through a housing that surrounds the rotating shaft with a plurality of mechanical bearings and an oil reservoir; and, placing a ferrofluid seal within the housing and around the rotating shaft on the downhole side of the bearings and oil reservoir.

### BRIEF DESCRIPTION OF THE DRAWING

FIG. 1 illustrates a cross-sectional view of one embodiment of a seal assembly including a ferrofluid seal for a wireline downhole application.

FIG. 2 illustrates an enlarged cross-sectional view of the end of the seal assembly of FIG. 1.

FIG. 3 illustrates a cross sectional view of the seal assembly of FIG. 1 and FIG. 2 with a baffled bushing.

FIG. 4 illustrates a cross sectional view of the seal assembly of FIG. 1 and FIG. 2 with a modified magnetic assembly design.

### DETAILED DESCRIPTION OF THE PREFERRED EMBODIMENTS

Magnetic liquid seals are used in rotating equipment to enable rotary motion while maintaining a hermetic seal by means of a physical barrier in the form of a ferrofluid. The ferrofluid is suspended in place by the use of magnets. The use of ferrofluid seal concepts in the computer hard drive industry is well known and documented. However, the application of a ferrofluid seal in the wireline tool environment is novel and non-obvious at least because of the challenges with implementing such a seal in the extreme temperatures and pressures and its application as a liquid seal. Moreover, the design of the conventional ferrofluid seal will not work in downhole applications and the modification to the design taught herein are required to create a ferrofluid seal that works in such an environment.

Conventional ferrofluid seals are most always gas seals. These types of ferrofluid seals cannot be used in downhole applications due to contamination by borehole fluid. Moreover, until recently, no permanent magnets existed with high enough field strengths and curie temps to support a good service life in downhole applications. Available products are focused on the high-vacuum, space and wide temperature markets (rotating seal on a sintering furnace, spacecraft or plasma chamber, for example). The fluid bases used on conventional ferrofluid seals are all formulated to provide extremely low vapor pressures, high service temperature and high viscosity and ensure a gas seal under relatively low pressure differentials. These seals are not compatible with the fluids found in downhole applications nor are typical ferrofluid seals useable with pressure differentials above about 200 Kpa.

The embodiments described herein overcome the deficiencies of conventional ferrofluid seals with respect to downhole applications. The embodiments described herein are more robustly built and use a specialized hydraulic fluid base that modifies the typical ferrofluid seal and makes it suitable for downhole applications. The embodiments described herein combine the overall wide temperature sealing properties of ferrofluid seals with a specialized hydraulic fluid base and some of the techniques of downhole mechanical seals to create a hybrid seal. Although the hybrid seals may forego some of the other beneficial properties of existing ferrofluid seals, they are a robust and suitable downhole seal that has very low friction, very wide service temperature and does not leak when exposed to high differential pressures.

Ferrofluid seals have a number of advantages including lower maintenance costs, longer life, reduced tool damage due to ingress of corrosive borehole fluids, and long operating life. Moreover, the drag torque can be designed to be very low. Accordingly, ferrofluid-sealed feedthroughs can reach performance levels that other technologies cannot achieve.

In some embodiments of the disclosed ferrofluid seal designs, a ferrofluid seal is formed by a slurry of ferromagnetic nano/micro particles and oil or grease placed in a suitably designed series of channels in the seal assembly and biased using a static magnetic field. The slurry is retained magnetically between rotor and stator providing a compliant seal with no significant wear, immunity to leakage by thermal expansion and significantly reduced friction.

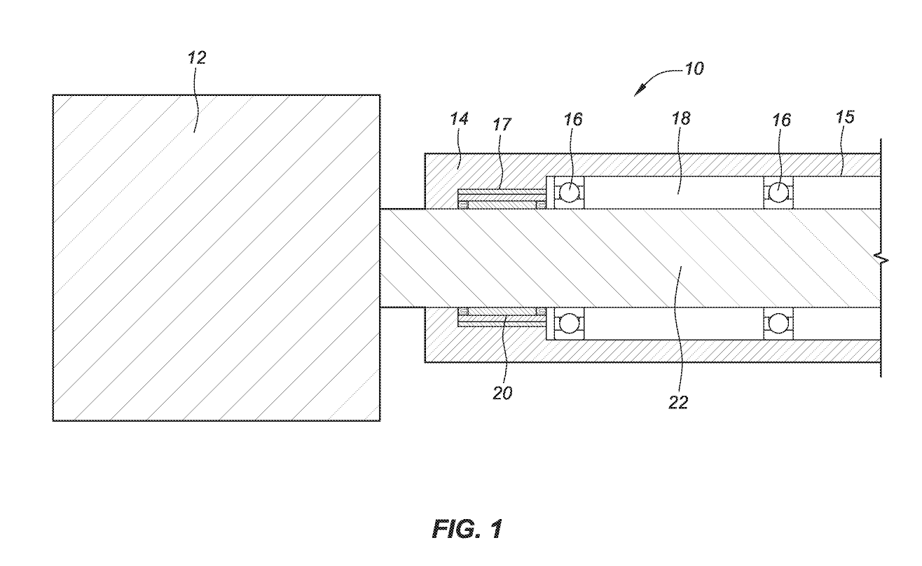

FIG. 1 illustrates a cross-sectional view of one embodiment of a seal assembly 10 including a ferrofluid seal 20 for a wireline downhole application. In preferred embodiments, the assembly 10 is encased in a housing 14. The housing 14 can be made from any appropriate material including any metal but preferably is made from steel or another high strength material In a preferred embodiment, the housing is made from a high strength stainless steel such as 17-4. The housing surrounds a rotating shaft 22 and confines the separate components of the seal assembly 10.

If the seal assembly is used in a wireline application, then the rotating shaft 22 will typically have a sensor 12 mounted on the end as shown in FIG. 1. The sensor 12 may be any type of sensor and of course will rotate with the rotating shaft. The embodiments disclosed herein are not limited to wireline applications and the sensor 12 is not required. In fact, the seal assembly 10 may be used with any type of rotating shaft.

The housing 14 is bored out along its longitudinal axis to allow the rotating shaft 22 to pass through the housing. Depending on the embodiments, the housing 14 may have a number of different bores with different diameters along the longitudinal axis of the housing. The embodiment shown in FIG. 1 has three different bores along the longitudinal axis of the housing. The first diameter bore passes all the way through the housing 14 and has a radius designed to allow the rotating shaft 22 to pass through. The second diameter bore 17 has a slightly larger diameter and does not pass all the way through the housing but stops short of the end and is sized to hold the ferrofluid seal 20. The third diameter bore 15 is slightly larger than the second diameter bore 17 and extends along the longitudinal axis of the housing 14 up to the second diameter bore 17. The third diameter bore 15 is sized to allow for the mechanical bearings 16 and as a reservoir 18 to hold the oil fill, which is compensated to the borehole condition.

As may be seen in FIG. 1, the housing 14 encases at least one shaft bearing 16. As mentioned above, the shaft bearings 16 are located in the third diameter bore 15. In the embodiments shown in FIG. 1, two shaft bearings 16 are used. However, in other embodiments, more shaft bearings 16 may be used. Although a single shaft bearing 16 could be used, it is not a preferred embodiment as at least two shaft bearings 16 are needed to stabilize the shaft 22.

The space between the shaft bearings 16 in the third diameter bore 15 is a reservoir 18 for oil fill or an oil fill region 18. As would be expected from the name, the reservoir 18 is filled with oil. The oil in the reservoir 18 may be any type of oil but in preferred embodiments is a hydraulic oil. The oil is used to compensate the interior to a pressure that is approximately 100 psi greater than that of the atmosphere. The secondary purpose of the oil is to lubricate the rotating equipment like the gear box and motor that are connected to the shaft 22. The oil in the oil fill region 18 is compensated to the borehole conditions. If the interior of the tool were not compensated to the borehole conditions the seal would have to hold back up to extreme pressures. (potentially around 20.000 psi) and to do so would require a seal that would prevent the rotation of the shaft.

In addition, the housing 14 encases a ferrofluid seal 20. The ferrofluid seal 20 is located at the downhole end of the housing 14 where the shaft 22 exits the housing 14. As already mentioned above, in the embodiment of FIG. 1, the ferrofluid seal 20 is located in the second diameter bore 17. The ferrofluid seal 20 surrounds the rotating shaft 22 and forms a seal between the interior of the housing 14 and the exterior of the housing 14. The ferrofluid seal 20 prevents any solid, gas or liquid from passing along the surface of the rotating shaft from the exterior of the housing 14 up the shaft 22 into the any other portion of the housing 14 including the third diameter bore 15. In addition, the ferrofluid seal 20 prevents any of the oil in the oil fill region 18 from passing down along the surface of the rotating shaft 22 past the ferrofluid seal 20 to the exterior of the housing 14.

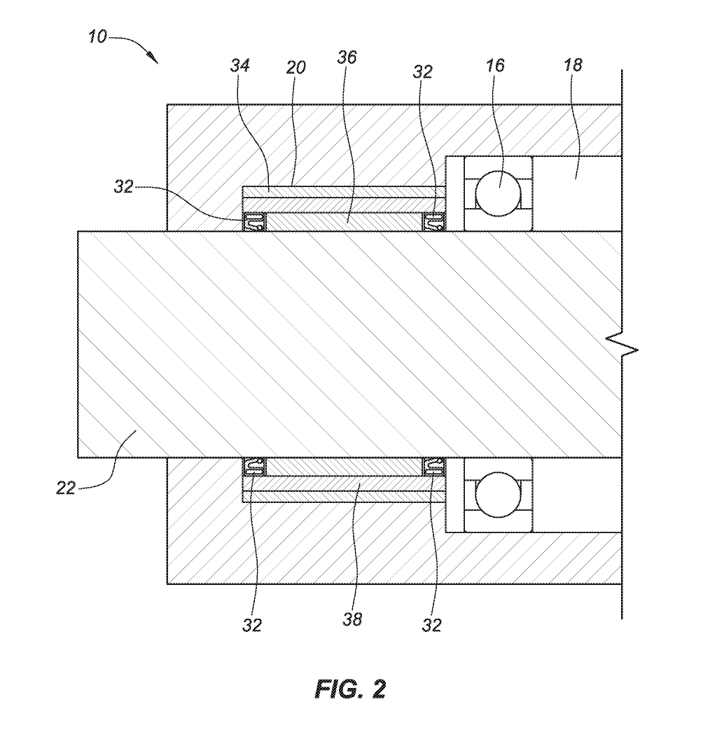

FIG. 2 illustrates an enlarged cross-sectional view of the end of the seal assembly 10 of FIG. 1. FIG. 2 illustrates the cross-section of one embodiment of a ferrofluid seal 20 more closely. As may be seen, the ferrofluid seal 20 is located at the end of the housing 14 and surrounds the rotating shaft 22.

In the embodiment of a ferrofluid seal 20 shown in FIG. 2, the ferrofluid seal 20 comprises: a magnet assembly 34; bushing 38; a ferrofluid barrier 36; and a plurality of elastomer lip seals 32. The ferrofluid seal 20 in concentric with and encircles the rotating shaft 22.

The magnetic assembly 34 comprises the outside of the ferrofluid seal 20. The magnets in the magnetic assembly are permanent magnets. In the embodiment shown in FIG. 2, the magnetic assembly 34 is made from a single continuous permanent magnet that is cylindrically shaped. As is known by those skilled in the art, the magnets are positioned, shaped and sized to create a magnetic field that keeps the ferrofluid 36 in place. The magnets may be custom shaped to fit in the envelope of the seal design.

Inside the magnetic assembly 34 is a bushing 38. The bushing sits on the inside surface of the magnetic assembly 34 and separates the magnetic assembly from the ferrofluid 36.

The magnetic assembly 34 and the bushing 38 are concentric with and encircle the rotating shaft 22 but both have a slightly larger diameter than the rotating shaft 22 leaving a gap between the inside surface of the bushing 38 and the outside surface of the rotating shaft 22. The gap is filled with a ferrofluid 36. The ferrofluid 36 may be any type of fluid that includes ferromagnetic particles. In preferred embodiments, the ferrofluid is a slurry of ferromagnetic nano/micro particles and oil or grease. Accordingly, in some embodiments, the ferrofluid may be considered a ferrofluid grease 36. Preferably, the ferrofluid grease is a high temperature oil or grease or mixture of the two. The oil or grease or mixture thereof may be loaded with micro or Nano Nickel particles.

In yet other embodiments, the ferrofluid 36 may be a liquid ferromagnetic alloy in lieu of an oil/metal slurry. One example could use Galinstan® (−2 deg F. MP) or a similar material comprised of approximately 68 wt % Ga, 22 wt % In and 10 wt % Sn. In different embodiments, the ferrofluid compositions may vary between 62 wt % and 95 wt % Ga, 5 wt % and 22 wt % In, 0 wt % and 16 wt % Sn. In yet other embodiments, Eutectic Gallium-Indium (“EGaIn”) may be used. In preferred embodiments. EGaIn is comprised of about 75 wt % Ga and 25 wt % In with approximately 15.5° C. melting point. In these alternate embodiments, the EGaIn. Galistan® or other liquid may be amalgamed with Fe or Ni particles to make a ferrometal alloy. In yet other embodiments, other ferrofluids may be used.

In preferred embodiments, each exterior edge of the gap has an elastomer seal 32. In preferred embodiments, the elastomer seals 32 are each in the form of a ring that take up the gap between the outside surface of the rotating shaft 22 and the inside surface of the bushing 38. Each elastomer seal 32 is on one end of the ferrofluid seal 20 such that one elastomer seal 32 is on the downhole end of the ferrofluid seal 20 and one elastomer seal 32 is on the opposite side of the ferrofluid seal 20. The two elastomer seals 32 bookend the ferrofluid 36 in the gap of the ferrofluid seal 20. In some embodiments, the elastomer seals 32 may be lip seals but in other embodiments other seal designs may be used. The elastomer seals 32 may be fluoroelastomers and made out of an FKM material as specified by ASTM D1418. The two elastomeric seals 32 are used in conjunction with the ferrofluidic grease barrier to achieve sealing between the interior and exterior of the housing 14.

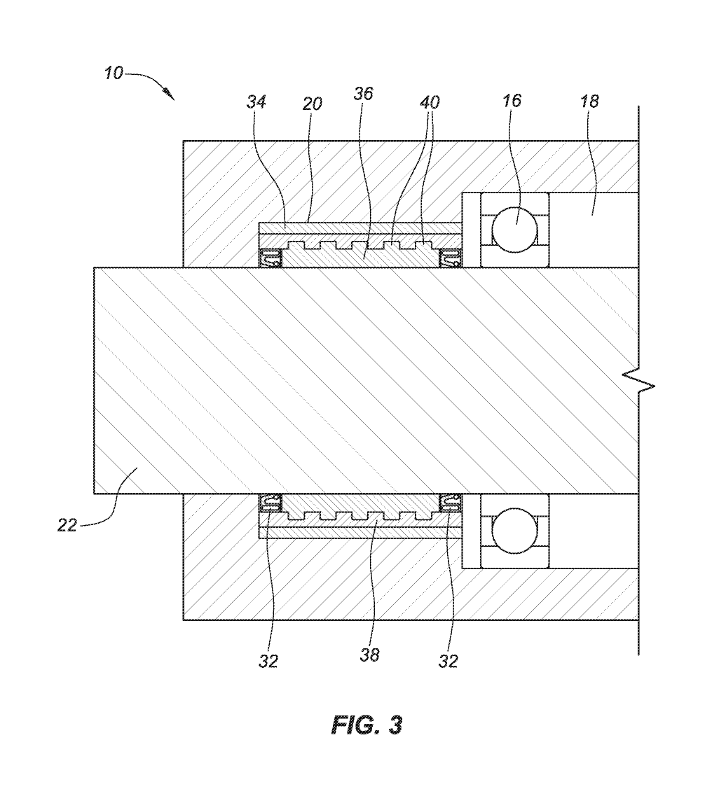

FIG. 3 illustrates a cross sectional view of the seal assembly of FIG. 1 and FIG. 2 with a baffled bushing 38. As may be seen in FIG. 3, the busing 38 has a plurality of channels 40 that are parallel to each other and run continuously along the inside surface of the bushing 38. The channels 40 form concentric rings or ridges on the inside surface of the bushing from the downhole end of the bushing 38 to the opposite side of the bushing 38. In the embodiment shown in FIG. 3, five channels are used but in other embodiments many more channels 40 can be used. In the embodiment shown in FIG. 3, the channels 40 are spaced one channel width from each other. However, in other embodiments, the channels size or channel spacing may be different. In preferred embodiments, the channel size and spacing is in the range of 0.0625 inches and 0.25 inches. In an even more preferred embodiment, the channel size and spacing is 0.125 inches. In the embodiment shown in FIG. 3, the channels are rectangular cuts into the surface of the bushing 38. However, in other embodiments, the channels may be “U” shaped, “V” shaped or another groove shape. In the embodiment of FIG. 3, the channels run parallel to each other along the inside surface of the bushing and are not connected one to the other. However, in other embodiments, the channels 40 may be cut as a thread or helix such that a single channel wraps continuously along the inside surface similar to a screw thread. In embodiments where the channels 40 are formed as a continuous helix or thread, the thread may have various different leads or pitches depending on the design.

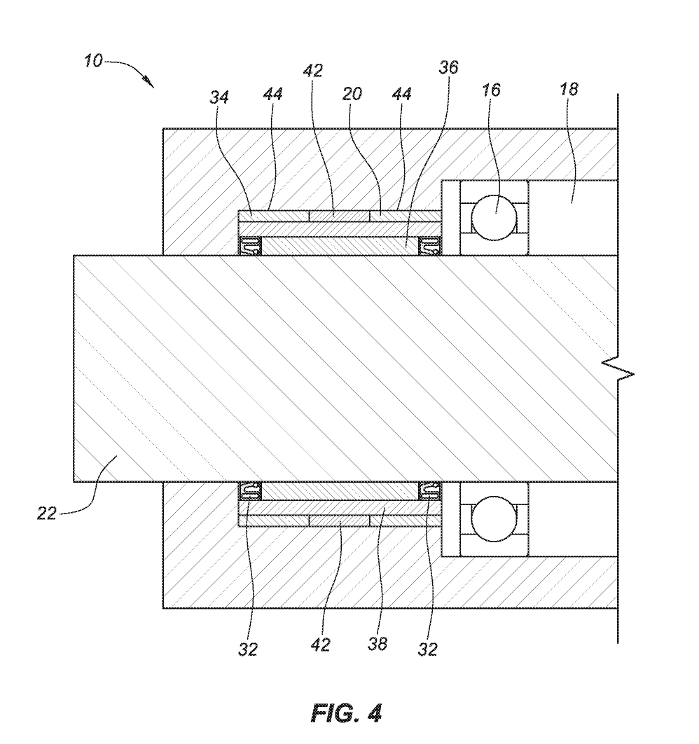

FIG. 4 illustrates a cross sectional view of the seal assembly of FIG. 1 and FIG. 2 with a modified magnetic assembly 34 design. In the embodiment of FIG. 4, the magnetic assembly 34 is formed from a plurality of permanent magnets 44. In the embodiment of FIG. 4, a first permanent magnet 44 shaped like a cylinder is positioned at downhole end of the magnetic assembly 34 and a second permanent magnet 44 also shaped like a cylinder is posited at the opposite end of the magnetic assembly. A pole 42 is formed in between the two permanent magnets 44. The pole 42 may simply be a gap between the two permanent magnets 44 or may be filled with a non-magnetic material.

Although the inventions have been described with reference to preferred embodiments and specific examples, it will readily be appreciated by those skilled in the art that many modifications and adaptations of the methods and devices described herein are possible without departure from the spirit and scope of the inventions as claimed hereinafter. In addition, elements of any of the embodiments described may be combined with elements of other embodiments to create additional embodiments. Thus, it is to be clearly understood that this description is made only by way of example and not as a limitation on the scope of the claims below.

What is claimed is:

1. A method of determining information inside a borehole comprising:
selecting at least one sensor to be lowered into the borehole;
coupling the sensor to the end of a rotating shaft;
running the rotating shaft through a housing including a plurality of bearings and an oil reservoir;
sealing a downhole end of the housing from an exterior of the housing with a ferrofluid seal; and
forcing the sensor, rotating shaft, housing, bearings, oil reservoir, and ferrofluid seal into the borehole.

2. The method of claim 1, wherein the ferrofluid seal includes an elastomer seal on each end of a ferrofluid reservoir.

3. The method of claim 2, wherein the elastomer seal on each end of the ferrofluid reservoir is a lip seal.

4. The method of claim 1, wherein the ferrofluid seal includes a ferrofluid reservoir made from a slurry of ferromagnetic particles combined with oil or grease.

5. The method of claim 1, wherein the ferrofluid seal includes a ferrofluid reservoir made from a slurry of ferromagnetic particles and a fluid comprising about 68 wt % Ga, 22 wt % In and 10 wt % Sn.

6. The method of claim 1, wherein the ferrofluid seal includes a bushing that has a plurality of channels formed on an inside surface of the bushing.

7. A ferrofluid seal designed to seal against a rotating shaft comprising:
a magnetic assembly with a cylindrically shaped interior that surrounds the rotating shaft including at least one permanent magnet;
a bushing between the cylindrically shaped interior of the magnetic assembly and the rotating shaft;
a reservoir of ferrofluid that surrounds the rotating shaft and is between the bushing and the rotating shaft;
an elastomer seal that forms a ring around the rotating shaft and is located on a downhole side of the reservoir and spans a gap between the bushing and the rotating shaft; and,
a second elastomer seal that forms a ring around the rotating shaft and is located on an opposite side of the reservoir from the downhole side and spans the gap between the bushing and the rotating shaft.

8. The ferrofluid seal of claim 7, wherein the first elastomer seal and the second elastomer seal are each a lip seal.

9. The ferrofluid seal of claim 7, wherein the reservoir of ferrofluid is made from a slurry of ferromagnetic particles combined with oil or grease.

10. The ferrofluid seal of claim 7, wherein the reservoir of ferrofluid is made from a slurry of ferromagnetic particles and a fluid comprising about 68 wt % Ga, 22 wt % In and 10 wt % Sn.

11. The ferrofluid seal of claim 7, wherein the bushing has a plurality of channels formed on an inside surface of the bushing.

12. The ferrofluid seal of claim 7, wherein the magnetic assembly comprises a first cylindrically shaped permanent magnet on a downhole end of the magnetic assembly and a second cylindrically shaped permanent magnet on an opposite end of the magnetic assembly wherein a pole is formed in between the first and second cylindrically shaped permanent magnets.

13. A method of sealing a rotating shaft on a downhole instrument comprising:
running the rotating shaft through a housing that surrounds the rotating shaft with a plurality of mechanical bearings and an oil reservoir; and,
placing a ferrofluid seal within the housing and around the rotating shaft on the downhole side of the bearings and oil reservoir.

14. The method of claim 13, wherein the ferrofluid seal includes an elastomer seal on each end of a ferrofluid reservoir.

15. The method of claim 14, wherein the elastomer seal on each end of the ferrofluid reservoir is a lip seal.

16. The method of claim 13, wherein the ferrofluid seal includes a ferrofluid reservoir made from a slurry of ferromagnetic particles combined with oil or grease.

17. The method of claim 13, wherein the ferrofluid seal includes a ferrofluid reservoir made from a slurry of ferromagnetic particles and a fluid comprising about 68 wt % Ga, 22 wt % In and 10 wt % Sn.

18. The method of claim 13, wherein the ferrofluid seal includes a bushing that has a plurality of channels formed on an inside surface of the bushing.
